(19) United States
(12) Patent Application Publication
(10) Pub. No.: US 2026/0121446 A1
(43) Pub. Date: Apr. 30, 2026

(54) HIGH AMPERAGE SERVICE DISCONNECT (HASD) SYSTEM AND METHOD FOR USE

(71) Applicant: OGE Energy Corp., Oklahoma City, OK (US)

(72) Inventors: Darryl F. Splawn, Oklahoma City, OK (US); Michael Swatek, Norman, OK (US)

(21) Appl. No.: 19/369,067

(22) Filed: Oct. 24, 2025

Related U.S. Application Data
(60) Provisional application No. 63/712,044, filed on Oct. 25, 2024.

(51) Int. Cl. H02J 13/00

(52) U.S. Cl. CPC H02J 13/36

(57) ABSTRACT

A system and method for opening and closing the circuit of an electrical system are disclosed herein. The system having at least one or more control device electrically coupled to a power source and a receiving structure and a remote communication device. The method comprising a control device receiving a signal from a remote communication device, wherein the signal comprises instructions and/or code that when processed by processor of the control device causes the control device to open or close a circuit between a power source and a receiving structure.

### CROSS REFERENCE TO RELATED APPLICATION

This application claims priority from and the benefit of U.S. Provisional Application 63/712,044 filed Oct. 25, 2024, which is incorporated herein by reference.

### FIELD OF THE DISCLOSURE

The disclosure generally relates to a high amperage service disconnection system and method for use therein. More particularly the disclosure relates to a system having a method for simultaneously connecting/disconnecting a plurality of phases of electricity.

### BACKGROUND

Electrical safety hazards have always been a concern for field service technicians in the utility industry. Traditionally, the process of disconnecting each phase of electricity is performed by hand, which then causes single phase disruption of service which can place the field technician in danger of a potential arc flash. Prior systems and methods fail to address the ability to substantially simultaneously disconnect a plurality of phases of electricity thereby removing the field technician from an arc flash hazard. Thus, there is a need to develop a new system and method for substantially simultaneously disconnecting multiple phases of electricity.

### SUMMARY

By providing a system and method for substantially simultaneously disconnecting multiple phases of electricity, the risk of arc flash by a field technician is reduced. The disclosed implementations provide a system, comprising a power source; a receiving structure electrically coupled to a power source; and a remote communication device configured to open or close a circuit between the power source and the receiving structure. In some non-limiting implementations, the system is further comprising one or more control devices, wherein the one or more control devices includes a first control device comprising a first switch and a momentary switch, wherein the first switch has an on position, an off position, and an auto position. In some non-limiting implementations, the system is further comprising a second control device configured to bi-directionally communicate with the remote communication device when the first switch of the first control device is positioned in the auto position. In some non-limiting implementations, the second control device of the system is configured to communicate electricity to the third control device. In some non-limiting implementations, the system is further comprising a third control device configured to receive electricity from the first control device or the third control device when the first switch of the first control device is positioned in the on position and the momentary switch engaged. In some non-limiting implementations, the system is further comprising an insulation device electrically coupled to the power source and receiving structure. In some non-limiting implementations, the system is further comprising a voltage reduction device electrically coupled to the power source and the receiving structure. In some implementations, the system further comprises a container. In some implementations, the system is further comprising one or more coupling points positioned within the container.

The inventive concept disclosed herein further provides a method of controlling the flow of electricity from a power source to a receiving structure, comprising electrically coupling a power source to one or more control devices; electrically coupling the one or more control devices to a receiving structure; receiving a signal from a remote communication device, wherein the signal comprises processor executable instructions that when executed by a processor of the one or more control device causes the control device to open or close a circuit between the power source and the receiving structure. In some non-limiting implementations, the method further comprising providing a system comprising a first control device coupled to the power source; a second control device electrically coupled to the first control device; and a third control device electrically coupled to the first control device, the second control device and the receiving structure; and positioning a switch of the first control device in an auto position causing the second control device to open or close the circuit between the power source and the receiving structure upon receiving a signal. In some non-limiting implementations, the method is further comprising communicating electricity from the second control device to the third control device; generating a magnetic field from an electrical coil of the third control device; and closing the circuit between the power source and the receiving structure.

In some implementations of the method, the engaging of a plurality of moving contacts of the third control device with a plurality of fixed contacts of the third control device causes the circuit between the power source and the receiving structure to close. In some non-limiting implementations, the method is further comprising providing a system, comprising a first control device coupled to the power source; a second control device electrically coupled to the first control device; and a third control device electrically coupled to the first control device, the second control device and the receiving structure; and positioning a switch of the first control device in an on position and having the momentary switch engaged thereby causing the circuit between the power source and the receiving structure to be closed. In some non-limiting implementations, the method is further comprising communicating electricity from the first control device to the third control device; generating a magnetic field from an electrical coil of the third control device; closing the circuit between the power source and the receiving structure. In some non-limiting implementations of the method the engaging a plurality of moving contacts of the third control device with a plurality of fixed contacts of the third control device causes the circuit between the power source and the receiving structure to close. In some non-limiting implementations, the method is further comprising receiving a signal from the remote communication device, wherein the signal comprises processor executable instructions and/or code that when executed by a processor of the second control device causes the second control device to open or close the circuit between the power source and the receiving structure. In some non-limiting implementations of the method, the signal from the remote communication device comprises processor executable instructions and/or code comprising instructions to cease communicating electricity to the third control device, thereby causing the circuit between the power source and receiving structure to open. In some non-limiting implementations, the method further comprises ceasing to produce a magnetic field from an electrical coil of the third control device thereby causing a plurality of moving contacts of the third control device to disengage from a plurality of fixed contacts of the third control device thereby causing the circuit between the power source and the receiving structure to open. In some non-limiting implementations, the method is further comprising reducing electricity from the power source greater than approximately 251 volts to approximately 120 volts.

Further features, advantages, and properties of the system and method of the present application will become apparent from the detailed description.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 illustrates an exemplary system positioned relative to a receiving structure in accordance with the present disclosure.

FIG. 2 illustrates a schematic diagram of the exemplary system in accordance with the present disclosure.

FIG. 3 illustrates a schematic diagram of an exemplary second control device of the system in accordance with aspects of the present disclosure.

FIG. 4 illustrates an exemplary third control device of the system positioned in an open position in accordance with the aspects of the present disclosure.

FIG. 5 illustrates the exemplary third control device of the system positioned in a closed position in accordance with aspects of the present disclosure.

FIG. 6 illustrates an exemplary insulation device of the system in accordance with aspects of the present disclosure.

FIG. 7 illustrates a schematic diagram of an exemplary remote communication device in accordance with the present disclosure.

FIG. 8 illustrates a block diagram of the system for use with a plurality of remote communication devices in accordance with aspects of the present disclosure.

### DETAILED DESCRIPTION

The following detailed description refers to the accompanying drawings. The same reference numbers in different drawings may identify the same or similar elements. Before explaining at least one implementation of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other implementations or of being practiced or carried out in various ways. It should also be understood that the phraseology and terminology employed herein for purposes of description and should not be regarded as limiting.

The mechanisms proposed in this disclosure circumvent the problems described above. The present disclosure describes a system and method for substantially simultaneously connecting/disconnecting a plurality of phases of electricity thereby removing the field technician from an arc flash hazard.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

In addition, use of the “a” or “an” are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), a combination of hardware and software, and/or the like. The term “processor” as used herein means a single processor or multiple processors working independently or together to collectively perform a task.

Software may include one or more computer readable instructions, also referred to as executable code, that when executed by one or more components cause the component to perform a specified function. It should be understood that the algorithms described herein may be stored on one or more non-transitory computer readable mediums.

Exemplary, non-transitory computer readable mediums may include random access memory, read only memory, flash memory, and/or the like. Such non-transitory computer readable mediums may be electrically based, optically based, magnetically based, and/or the like. Non-transitory computer readable medium may be referred to herein as non-transitory memory.

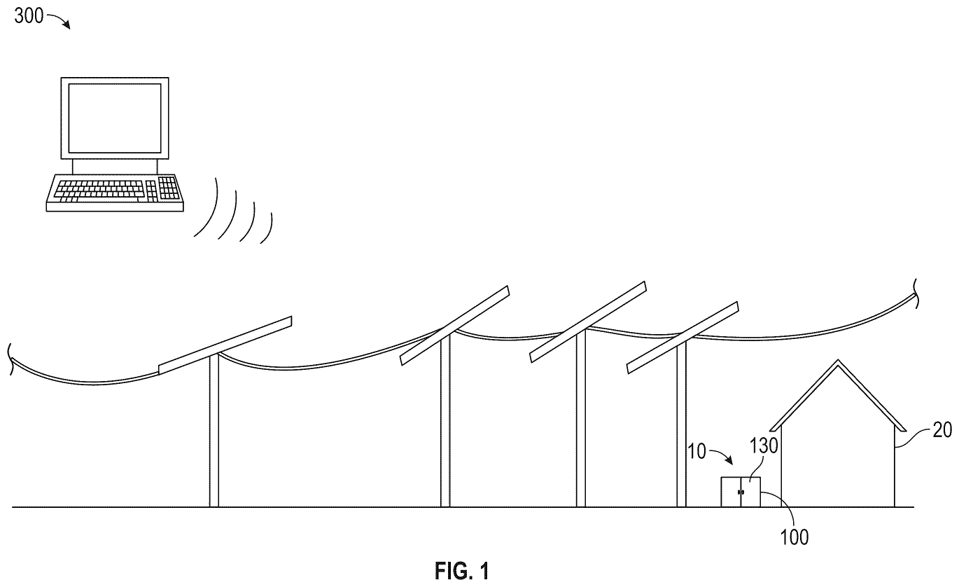

Referring now to the drawings, the system 10 shown in FIG. 1 illustrates an exemplary system 10 positioned relative to a receiving structure 20. In some non-limiting implementations, the system 10 may be positioned on a utility pole, adjacent the receiving structure 20, on the receiving structure 20, or the like. The receiving structure 20 may be a home, building, or the like.

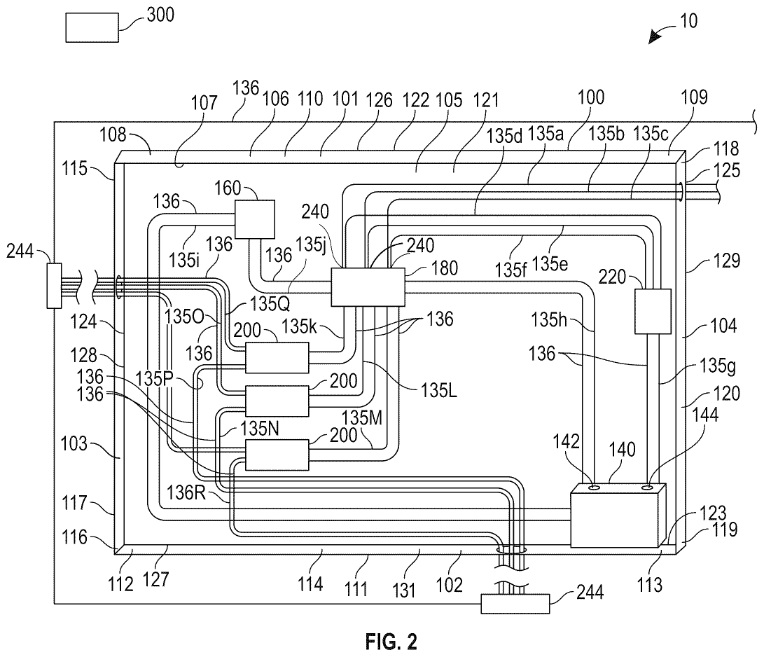

FIG. 2 illustrates a schematic diagram of an exemplary system 10 in accordance with the present disclosure. As shown in FIG. 2, the system 10 may comprise a container 100, one or more conductors 135, one or more control devices 140, one or more insulation devices 200, and a remote communication device 300 (also shown in FIG. 1). In some non-limiting implementations, the system 10 may further comprise one or more voltage reduction devices 220.

In some non-limiting implementations, a power source (not shown) may be electrically coupled to one or more components of the system 10 via one or more conductors 135. The power source may be electrically coupled to the one or more control devices 140, the one or more insulation devices 200, and the receiving structure 20. In some non-limiting implementations, the power source may be positioned outside of the container 100 of the system 10 or within the container 100 of the system 10. In some non-limiting implementations, the power source may be electrically coupled to the one or more voltage reduction devices 220. In some non-limiting implementations, the power source of the system 10 may be electrically coupled to one or more coupling points 240 via one or more conductors 135. The power source may be configured to communicate voltage, current, Watts, amperes, or combination thereof to one or more components of the system 10. For purposes of this disclosure, but in no way limiting, the volts, Watts, amperes, or combination thereof communicated from the power source to the one or more components of the system 10 may be referred to herein as electricity. The power source may be configured to conduct electricity as an alternating current (“AC”) and/or a direct current (“DC”). For purposes of the disclosure, the electricity conducted from the power source to the one or more components of the system 10 may be described as an alternating current;

however, a person of ordinary skill in the art would understand how an AC system may be substituted by a DC system. For purposes of the disclosure, the term “conduct” may be used interchangeably with the term “communicate” to describe the flow of electricity between the components of the system 10; however, a person of ordinary skill in the art would understand how the electricity is communicated within the system 10.

As shown in FIGS. 1 and 2, the container 100 of system 10 may have a first sidewall 101, a second sidewall 102 positioned opposite the first sidewall 101, a third sidewall 103 positioned substantially perpendicular to and extending between the first sidewall 101 and the second sidewall 102, a fourth sidewall 104 positioned opposite the third sidewall 103 and substantially perpendicular to and extending between the first sidewall 101 and the second sidewall 102, a front wall (not shown), and a back wall 105. In some implementations, the first sidewall 101 may have a top surface 106, a bottom surface 107, a first end 108, a second end 109, an intermediate member 110 extending between the first end 108 and second end 109. In some implementations, the second sidewall 102 may have a top surface 131, a bottom surface 111, a first end 112, a second end 113, and an intermediate member 114 extending between the first end 112 and the second end 113. In some implementations, a third sidewall 103 having a first end 115, a second end 116, and an intermediate member 117 extending between the first end 115 and the second end 116, wherein the first end 115 of the third sidewall 103 may be positioned adjacent and substantially perpendicular to the first end 108 of the first sidewall 101 such that the second end 116 of the third sidewall 103 may be positioned adjacent and substantially perpendicular to the first end 112 of the third sidewall 103. In some implementations, the fourth sidewall 104 may have a first end 118, a second end 119, and an intermediate member 120 extending between the first end 118 and the second end 119. In some implementations, the first end 118 of the fourth sidewall 104 may be positioned adjacent and substantially perpendicular to the second end 109 of the first sidewall 101 such that the second end 119 of the fourth sidewall 104 is positioned adjacent and substantially perpendicular to the second end 113 of the second sidewall 102. The back wall 105 of the container 100 may have a front surface 121 and a back surface (not shown) positioned substantially opposite of the front surface 121, a first side 122 and a second side 123 positioned substantially opposite the first side 122, a third side 124 extending between the first side 122 and the second side 123, and a fourth side 125 positioned substantially opposite the third side 124 extending between the first side 122 and second side 123. The front surface 121 of the back wall 105 may be positioned on a back side 126 of the first sidewall 101, a back side 127 of the second sidewall 102, a back side 128 of the third sidewall 103, and a back side 129 of the fourth sidewall 104 such that the back wall 105 extends between the first sidewall 101, the second sidewall 102, the third sidewall 103, and the fourth sidewall 104. In some non-limiting implementations, the back wall 105 may be positioned within and extend between the one or more inner surfaces of the first sidewall 101, the second sidewall 102, the third sidewall 103, and the fourth sidewall 104.

In some implementations, the container 100 may have a front wall (not shown), wherein the front wall of the container 100 may have a front surface and a back surface positioned substantially opposite of the front surface, a top side and a bottom side positioned substantially opposite the top side, a left side extending between the top side and the bottom side, and a right side positioned substantially opposite the left side extending between the top side and bottom side. In some non-limiting implementations, the top side of the front wall may be attached to the first sidewall 101 via one or more hinges such that the front wall may be positioned in a closed position or an open position. In other implementations, the front wall may be attached to the second sidewall 102 via one or more hinges positioned between the first end 112 and the second end 113 of the second sidewall 102 such that the front wall may be positioned in a closed or open position. In some non-limiting implementations, the front wall may be attached to the third sidewall 103 via one or more hinges positioned between the first end 115 and the second end 116 of the third sidewall 103 such that the front wall may be positioned in a closed or open position. In some non-limiting implementations, the front wall may be attached to the fourth sidewall 104 via one or more hinges positioned between the first end 118 and the second end 119 of the fourth sidewall 104 such that the front wall may be positioned in a closed or open position. In some implementations, the container 100 may have a one or more doors 130 (as seen in FIG. 1). In some non-limiting implementations, the one or more doors 130 may be attached to the first sidewall 101 and the second sidewall 102 via one or more hinges such that the one or more doors 130 may be positioned in an open or closed position. In some non-limiting implementations, the one or more doors 130 may be attached to the third sidewall 103 and the fourth sidewall 104 via one or more hinges such that the one or more doors 130 may be positioned in an open or closed position. In some non-limiting implementations, the container 100 may be constructed of metal, rubber, plastic, or the like. In some non-limiting implementations, the container 100 may be an electrical box, a junction box, a self-contained class 3 enclosure, a NEMA 3 approved enclosure, or the like. In some non-limiting implementations, the container 100 may not have one or more hinges such that the front wall of the container 100 may be removably positioned substantially opposite the back wall 105 by being positioned within and extend between the one or more inner surfaces of the first sidewall 101, the second sidewall 102, the third sidewall 103, and the fourth sidewall 104 or by being configured to be removably attached to the one or more outer surfaces of the first sidewall 101, the second sidewall 102, the third sidewall 103, and the fourth sidewall 104 thereby enclosing the container 100.

As seen in FIG. 2, the system 10 may have one or more conductors 135. In some non-limiting implementations, the system 10 may have a plurality of conductors 135a, 135b, 135c, . . . 135n (see FIG. 2), wherein the reference number 135a, 135b, 135c, . . . 135n may be used interchangeably with the reference number 135. In the illustrated implementation, the system 10 has a plurality of conductors 135a-135r, however, the number of conductors 135 may vary as required by the system 10. By way of example, but in no way limiting, one or more conductors 135 of the system 10 may be configured to communicate and/or “carry” electricity from the power source to the system 10 such that electricity may be communicated to one or more components of the system 10 and/or from the power source to one or more receiving structures 20. In some non-limiting implementations, the one or more conductors 135 of the system 10 may be configured to conduct, communicate and/or “carry” electricity to one or more panel members 244 of the receiving structure 20. In some non-limiting implementations, the one or more conductors 135 extending from the power source may be configured to be National Electrical Safety Code (NESC) compliant. In some non-limiting implementations, the one or more conductors 135 extending to the one or more panel members 244 of the receiving structure 20 may be configured to be National Electrical Code (NEC) compliant.

In some non-limiting implementations, the system 10 may have one or more neutral conductors 136, wherein the neutral conductor 136 may be configured to complete the circuit of the system 10 and return unused electricity to the power source. In some non-limiting implementations, the one or more conductors 135 and/or the neutral conductor 136 may comprise of one or more electrically conductive materials and/or one or more non-conductive materials. In some implementations, the electrically conductive material may be copper, aluminum, or the like. In some implementations, the one or more non-conductive materials may be rubber, nylon, plastic, or the like. In some non-limiting implementations, the one or more electrically conductive materials may be positioned within the one or more non-electrically conductive materials. In some non-limiting implementations, the non-electrically conductive materials may be wrapped around the electrically conductive material. The one or more conductors 135 and/or neutral conductor 136 of the system 10 may be a wire, cable, or the like. In some implementations, the electrically conductive material of the one or more conductors 135 and/or the neutral conductor 136 of the system 10 may be one of a number of sizes such that the one or more conductors 135 may carry the voltage and/or current required for the system 10. It would be understood by those of ordinary skill in the art that the neutral conductor 136 would be configured to comply with one or more regulatory bodies like the NEC, NESC, or the like.

The system 10 may have one or more control devices 140, 160, 180. By way of example, but in no way limiting, the system of FIG. 2 discloses a first control device 140, a second control device 160, and a third control device 180. The reference numbers 140, 160, 180 may be used interchangeably with the reference number 140. However, the number of control devices 140, 160, 180 may vary as required by the system 10. The one or more control devices 140, 160, 180 of the system 10 may be configured to open or close the circuit of the system 10. By way of example, but in no way limiting, when the circuit of the system 10 is open, electricity may not be communicated from the power source to the receiving structure 20 and/or one or more panel members 244 of the receiving structure 20. Additionally, when the circuit of the system 10 is closed, electricity may be communicated from the power source to the receiving structure 20 and/or one or more panel members 244 of the receiving structure 20. In some non-limiting implementations, the one or more control devices 140, 160, 180 may be a switch, a solenoid, a relay, or the like.

In some non-limiting implementations, and as shown in FIG. 2, the first control device 140 may comprise a first switch 142. The first switch 142 may be positioned in three positions: an off position, an on position, and an auto position. The first switch 142 of the first control device 140 may be operable to open or close the circuit of the system 10. In some non-limiting implementations, the first control device 140 may further comprise a momentary switch 144, wherein the momentary switch 144 may be configured to close the circuit between the first control device 140 and the third control device 180 upon the momentary switch 144 being engaged by a user. The first control device may be a switch or the like.

In some non-limiting implementations, the first control device 140 may have the first switch 142 positioned in the off position thereby opening the circuit of the system 10 and disconnecting the flow of electricity within the system 10. In some non-limiting implementations, when the first control device 140 has the first switch 142 positioned in the auto position, electricity may be communicated to the second control device 160 thereby enabling the second control device 160 to communicate with one or more remote communication devices 300.

In some non-limiting implementations, when the first control device 140 only has the first switch 142 and the first switch 142 is positioned in the on position, also known to those of skill in the art as the manual position, the first control device 140 may communicate electricity directly and/or indirectly to the third control device 180. In some non-limiting implementations, when the first control device 140 has the first switch 142 and the momentary switch 144 and the first switch 142 is positioned in the on position, the momentary switch 144 must be engaged in order to close the circuit between the first control device 140 and the third control device 180 thereby allowing the first control device 140 to communicate electricity to the third control device 180.

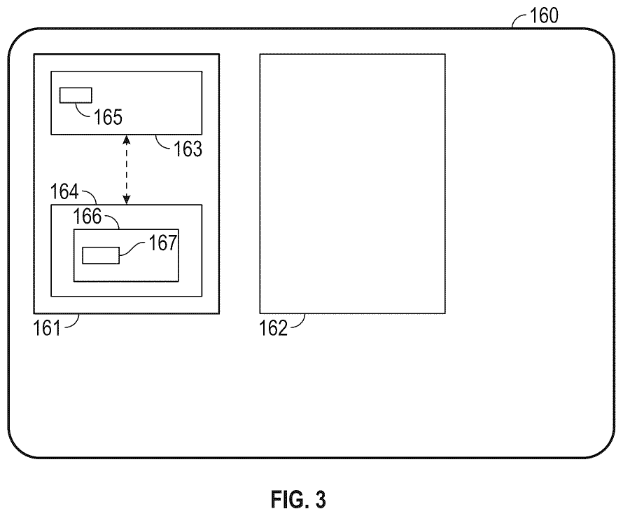

As disclosed in FIG. 2, the second control device 160 of the system 10 may be configured as a pass through for electricity from the first control device 140 to the third control device 180 and/or to communicate with one or more remote communication devices 300. In some non-limiting implementations, the second control device 160 may have a computing apparatus 161 and a relay apparatus 162. As seen in FIG. 3, the computing apparatus 161 of the second control device 160 may have one or more computer processors 163 and one or more non-transitory computer-readable mediums 164. The computing apparatus 161 of the second control device 160 may further comprise one or more communication components 165. In some non-limiting implementations, the communication component 165 may be positioned within the one or more processors 163 of the computing apparatus 161. The one or more non-transitory computer-readable mediums 164 of the computing apparatus 161 of the second control device 160 may have one or more databases 166 and/or program logic 167 wherein information such as processor executable instructions and/or code may be stored. In some non-limiting implementations, as seen in FIG. 3, the program logic 167 may be stored in the one or more databases 166 of the one or more non-transitory computer-readable mediums 164. When the processor executable instructions and/or code that are stored in the one or more databases 166 and/or program logic 167 are executed by the processor 163, the processor 163 may execute commands programmed within the instructions and/or code to allow the second control device 160 to receive a signal from the one or more remote communication devices 300. In some non-limiting implementations, the signal communicated from the one or more remote communication devices 300 may comprise processor executable instructions and/or code that when received by the second control device 160 and when executed by the one or more processors 163 of the second control device 160 causes the second control device 160 to communicate electricity to the third control device 180 or to discontinue communication of electricity to the third control device 180. By way of example, but in no way limiting, upon the second control device 160 receiving a signal from the one or more remote communication devices 300, wherein the signal comprises instructions and/or code to open the circuit of the system 10, the one or more processors 163 shall execute the processor executable instructions and/or code of the signal thereby causing the second control device 160 to discontinue supplying electricity to the third control device 180. By way of example, but in no way limiting, upon the second control device 160 receiving a signal from the one or more remote communication devices 300, wherein the signal comprises instructions and/or code to close the circuit of the system 10, the one or more processors 163 shall execute the processor executable instructions and/or code of the signal thereby causing the second control device 160 to supply electricity to the third control device 180. The one or more signals received by the second control device 160 may be communicated via a network 314, Bluetooth, WI-FI, application(s), or the like. The one or more signals may be communicated to the network 314 via Bluetooth, WI-FI, or the like. The processor executable instructions and/or code may be in the form of software and/or firmware, written in any suitable programming language. Suitable programming language may be C, C++, Python, Java, JavaScript, SQL, or the like. In some non-limiting implementations, when the first switch 142 of the first control device 140 is positioned in the on position, electricity may be communicated through the relay apparatus 162 of the second control device 160 to the third control device 180. In some non-limiting implementations, the second control device 160 may be a load control device, a load control switch, a remote-control switch, a cellular router, a cellular switch, or the like.

As shown in FIGS. 2 and 4-5, the system 10 may have a third control device 180 configured to substantially simultaneously connect or disconnect a plurality of phases of electricity 186. In some non-limiting implementations, the third control device 180 may have one or more moving contacts 182, one or more fixed contacts 184 positioned substantially across from the one or more moving contacts 182, and one or more electrical coils 185. In some non-limiting implementations, the one or more moving contacts 182 may be configured to engage the one or more fixed contacts 184 thereby connecting one or more phases of electricity 186. The electrical coil 185 may be configured to emit a magnetic field M upon the third control device 180 receiving electricity from the first control device 140 and/or the second control device 160. In some non-limiting implementations, the electrical coil 185 may not emit a magnetic field M when the third control device 180 does not receive electricity from the first control device 140 and/or the second control device 160. It is to be understood that a third control device 180 may have a plurality of moving contacts 182 and a plurality of fixed contacts 184 based on the needs of the system 10. It would also be understood to a person of ordinary skill in the art that the one or more moving contacts 182 and/or fixed contacts 184 may be constructed of a material that may be drawn to the magnetic field M.

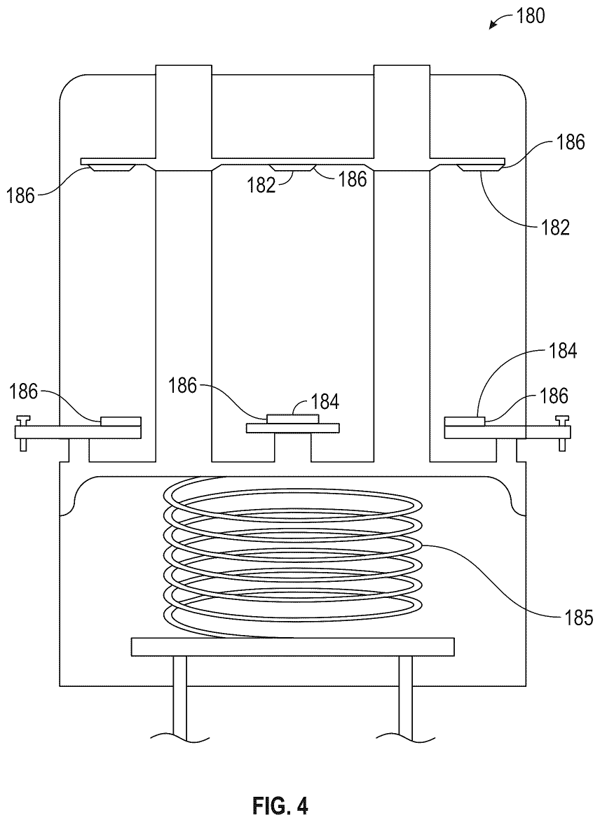

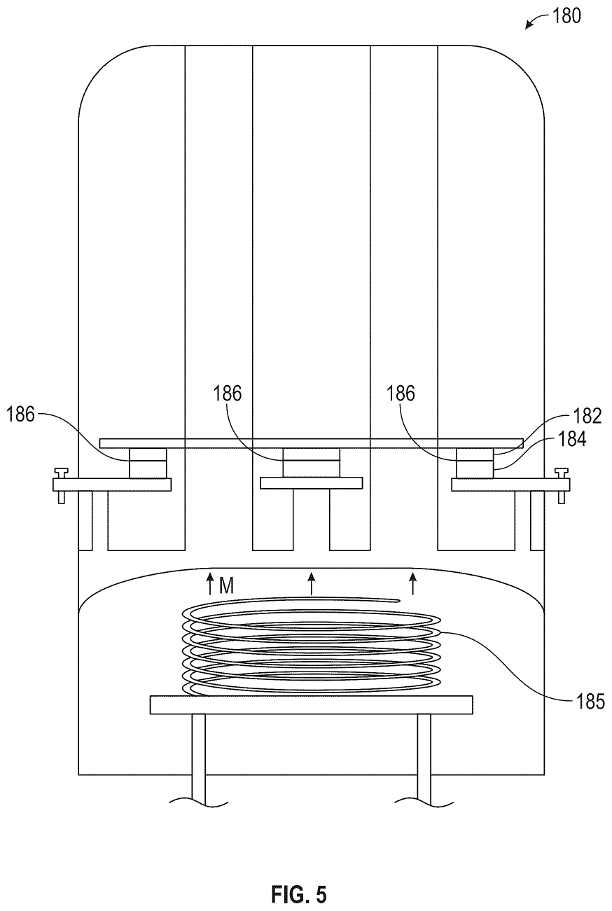

By way of example, but in no way limiting, the third control device 180 may be positioned in an open position (FIG. 4) or a closed position (FIG. 5). When the third control device 180 is in the open position, the circuit of the system 10 is open thereby disconnecting the flow of electricity from the power source to the receiving structure 20 and/or one or more panel members 244 of the receiving structure 20. The third control device 180 may be in the open position when the third control device 180 is not receiving electricity from the first control device 140 and/or the second control device 160. When the third control device 180 is in the closed position, the circuit of the system 10 is closed thereby allowing the flow of electricity from the power source to the receiving structure 20 and/or one or more panel members 244 of the receiving structure 20. The third control device 180 may be in the closed position when the third control device 180 receives electricity from the first control device 140 and/or the second control device 160. By way of example, but in no way limiting, FIG. 4 illustrates three electrically uncoupled phases of electricity 186 wherein the circuit of the system 10 is open and FIG. 5 illustrates three phases of electricity 186 electrically coupled wherein the circuit of the system 10 is closed via three moving contacts 182 engaging three fixed contacts 184.

As shown in FIG. 5, the third control device 180 may be positioned in the closed position when the third control device 180 receives electricity from the first control device 140 and/or the second control device 160 thereby causing the electrical coil 185 to emit the magnetic field M. In some non-limiting implementations, the magnetic field M of the electrical coil may cause the one or more moving contacts 182 to move in the direction of the one or more fixed contacts 184 until the one or more moving contacts 182 engages the one or more fixed contacts 184 thereby connecting the one or more phases of electricity 186 and closing the circuit of the system 10. In some non-limiting implementations, the third control device 180 may be positioned in the open position when the third control device 180 is not supplied power from the first control device 140 and/or the second control device 160 such that the electrical coil 185 does not provide the magnetic field M to move the one or more moving contacts 182 in the direction of the one or more fixed contacts 184. The third control device 180 may be a magnetic controller, a motor controller, or the like.

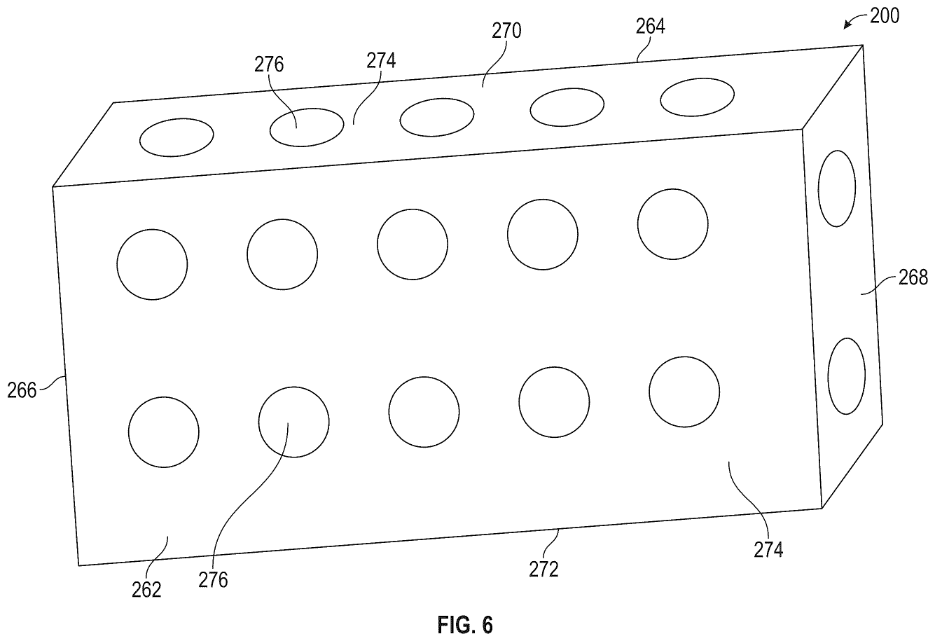

As shown in FIGS. 2 and 6, the system 10 may have one or more insulation devices 200. The one or more insulation devices 200 may have a first sidewall 262, a second sidewall 264 positioned opposite the first sidewall 262, a third sidewall 266 positioned substantially perpendicular to the first sidewall 262 and second sidewall 264 such that the third sidewall 266 extends between the first sidewall 262 and second sidewall 264, a fourth sidewall 268 positioned substantially opposite the third sidewall 266 and substantially perpendicular to the first sidewall 262 and the second sidewall 264 such that the fourth sidewall 268 extends between the first sidewall 262 and the second sidewall 264, a top surface 270, a bottom surface 272 positioned substantially opposite the top surface 270, a substrate 274 extending between the first sidewall 262, the second sidewall 264, the third sidewall 266, the fourth sidewall 268, the top surface 270, and the bottom surface 272, and one or more connection points 276. The one or more connection points 276 may be configured to connect one or more conductors 135 of the system 10 to one or more neutral conductors 136 extending from the receiving structure 20 and/or one or more panel members 244 of the receiving structure 20 thereby allowing electricity to be communicated from the power source to the receiving structure 20 and/or one or more panel members 244 of the receiving structure 20 so long as the circuit of the system 10 is closed. It is understood by a person of ordinary skill in the art that the insulation device 200 may have a plurality of connection points 276 depending on the needs of the system 10. In some non-limiting implementations, the substrate 274 of the one or more insulation devices 200 may be comprised of electrically conductive material such as aluminum, tin, steel, or the like.

In some non-limiting implementations, the insulation device 200 may have a covering member (not shown), wherein the covering member may be configured to insulate and thereby maintain the temperature of the insulation device 200. In some non-limiting implementations, the substrate 274 of the insulation device 200 may be positioned within the covering member of the insulation device 200. In the preferred implementation, the covering member of the insulation device 200 may be configured to insulate the insulation device 200 having a voltage between approximately 120 volts and approximately 480 volts. In some non-limiting implementations, the covering member of the insulation device 200 may be configured to insulate the insulation device 200 up to approximately 1000V. It is understood by persons of ordinary skill in the art that the covering member of the insulation device 200 may be configured to insulate the insulation device 200 having electricity in a range that is required by the system 10. In some non-limiting implementations, the covering member of the insulation device 200 may be a non-electrically conductive material such as rubber, nylon, plastic, or the like.

As shown in FIG. 2, and in some non-limiting implementations, when the electricity communicated from the power source is approximately 251 volts or greater, the system 10 may have a voltage reduction device 220. In some implementations, the voltage reduction device 220 may be configured to reduce the voltage of the electrical current from the power source by one or more “step down.” In some implementations, the electricity from the power source may have a voltage between approximately 120 volts to approximately 34,500 volts. In some implementations, the electricity from the power source may be 480 volts. In some implementations, the reduced electricity may be in the range of approximately 120 volts to approximately 480 volts. In some non-limiting implementations, the voltage reduction device 220 may be configured to reduce electricity having an amperage of approximately 200 amperes or greater. In some non-limiting implementations, the voltage reduction device may be positioned within the container 100. In some non-limiting implementations, the voltage reduction device 220 may be a step-down dry cell transformer, or the like.

In some non-limiting implementations, the system 10 may have one or more coupling points 240 positioned within the container 100. In some non-limiting implementations, the coupling points may have a base (not shown) and a fastening member (not shown). The one or more coupling points may be configured to electrically connect one or more conductors 135 of the system 10. By way of example, but in no way limiting, a first conductor 135a may connect to a second conductor 135d when a portion of a first conductor 135a is connected to the fastening member of the one or more coupling points 240 and a portion of a second conductor 135d is connected to the fastening member of the one or more coupling points 240. In some non-limiting implementations, the one or more coupling points may be positioned on an interior surface of the container 100, on an exterior surface of the container 100, one or more components of the system 10 such as the first control device 140, the second control device 160, the third control device 180, the voltage reduction device 220, or the like. The one or more fastening members of the one or more coupling points 240 may be a screw, rod, or the like.

In some non-limiting implementations, the system 10 may have a grounding device (not shown). The grounding device may be configured to connect the circuit of the system 10 to the earth such that excess electricity may be directed to the ground, the power source, or the like. In some non-limiting implementations, the system 10 may have a corner grounding device, common grounding device, or the like. The grounding device may be a rod, a plate, or the like.

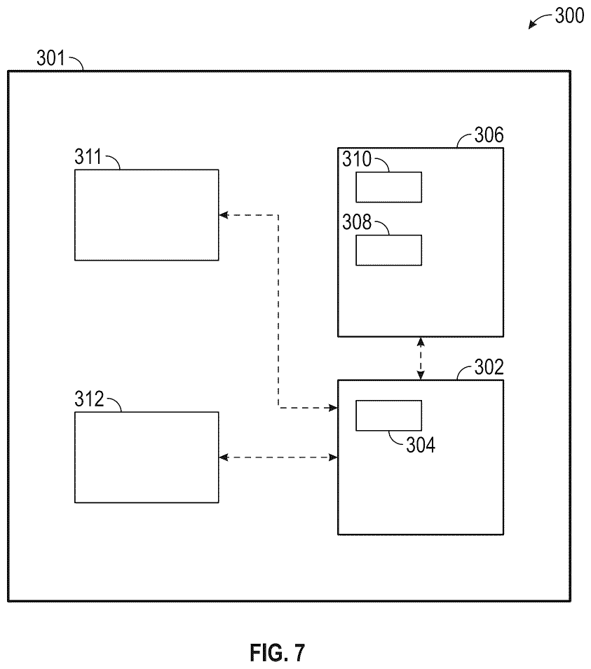

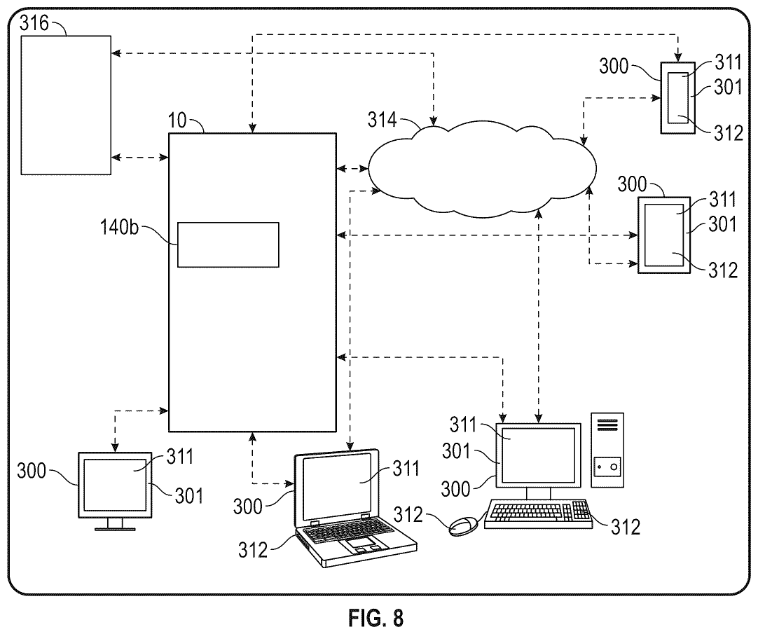

FIG. 7 discloses a diagrammatic view of the exemplary remote communication device 300 of the system 10 and FIG. 8 illustrates a block diagram of the system 10 for use with a plurality of remote communication devices 300. In some non-limiting implementations, the remote communication device 300 may have a housing 301, one or more processors 302, one or more communication components 304, one or more non-transitory computer readable mediums 306. In some non-limiting implementations, the one or more communication components 304 may be positioned within the one or more processors 302 (as shown in FIG. 7). In some non-limiting implementations, the one or more non-transitory computer readable mediums 306 of the remote communication device 300 may have one or more databases 308 and/or program logic 310 wherein information such as processor executable instructions and/or code may be stored. In some non-limiting implementations, the program logic 310 may be positioned within the one or more databases 308 of the non-transitory computer readable medium 306. In some non-limiting implementations, the remote communication device 300 may have one or more output components 311. In some non-limiting implementations, the remote communication device 300 may have one or more input components 312. In some non-limiting implementations, the remote communication device 300 may be configured to bi-directionally communicate with one or more control devices 140 to connect or disconnect one or more phases of electricity 186 of the system 10. By way of example, but in no way limiting, the remote communication device 300 is described herein as communicating with the second control device 160, however, it is understood by those of ordinary skill in the art that the remote communication device 300 may be configured to communicate with any control device 140 having a communication component.

The one or more processors 302 of the remote communication device 300 may be configured to execute processor executable instructions and/or code stored in the one or more databases 308 and/or program logic 310 that when executed by the processor 302, may cause the processor to execute commands programmed within the instructions and/or code to allow the one or more processors 302 of the remote communication device 300 to bi-directionally communicate information and/or data via one or more signals to the second control device 160 of the system 10, the network 314, the one or more non-transitory computer readable mediums 306 of the remote communication device 300, the output component 311 of the remote communication device 300, the input component 312 of the remote communication device 300, or the like. The one or more signals may be communicated to the second control device 160 of the system 10 via the network 314, Bluetooth, WI-FI, application(s), or the like. The one or more signals may be communicated to the network 314 via Bluetooth, WI-FI, or the like. The processor executable instructions and/or code may be in the form of software and/or firmware, written in any suitable programming language. Suitable programming language may be C, C++, Python, Java, JavaScript, SQL, and the like. In some non-limiting implementations, the processor 302 may be configured to interface and/or communicate via the communication component 304 by exchanging one or more signals (e.g., analog, digital, optical, and/or the like). In some non-limiting implementations, the one or more processors 302 may be configured to create, manipulate, retrieve, alter, and/or store data structures in the non-transitory computer readable medium 306 of the remote communication device 300 or a database of a non-transitory computer readable medium of the external system, such as a cloud based system (not shown). In some non-limiting implementations, the processor 302 of the remote communication device 300 may be a single processor or multiple processors working together, or independently. The one or more processors 302 may be, but is not limited to, a digital signal processor (DSP), a central processing unit (CPU), a microprocessor, a multi-core processor, combinations thereof and/or the like. The one or more signals may be communicated to the second control device 160 and/or the network 314 via Bluetooth, WI-FI, network, DSL, or the like.

In some non-limiting implementations, the one or more communication components 304 of the remote communication device 300 may be positioned within the one or more processors 302 as shown in FIG. 7. In some non-limiting implementations, the one or more communication components 304 may not be positioned within the one or more processors 302 of the remote communication device 300. The one or more communication components 304 of the remote communication device 300 may be configured to bi-directionally communicate one or more signals with the second control device 160 of the system 10, the network 314, or the like. (FIG. 7). The one or more signals may be communicated to the second control device 160 via Bluetooth, WI-FI, network, DSL, or the like. The one or more signals may be communicated to the network via Bluetooth, WI-FI, DSL, or the like.

The one or more output components 311 of the remote communication device 300 may be configured to output information in a form perceivable by the user. In some non-limiting implementations, the output components 311 may be visual output component, an audible output component, and/or the like. In some limiting implementations, a visual output component may be a display screen, a graphical user interface, touchscreen, website, a light, such as an LED, or the like.

In some non-limiting implementations, the remote communication device 300 may have one or more input components 312 configured to receive information from the user and/or one or more processors 302 of the remote communication device 300. The one or more input components 312 may include, but is not limited to, a keyboard, touchscreen, mouse, trackball, microphone, fingerprint reader, infrared port, slide-out keyboard, flip-out keyboard, cell phone, PDA, remote control, wearable communication device network interface, combinations thereof, and/or the like. It is to be understood that in some exemplary implementations, the output component 311 and the input component 312 may be implemented as a single device, such as, for example, a touchscreen of a computer, a tablet, or a smartphone (as seen in FIG. 8). It is to be further understood that as used herein the term user is not limited to a human being, and may comprise a computer, a server, a website, a processor, a network interface, a human, a user terminal, a virtual computer, combinations thereof, and/or the like.

In one implementation, the network 314 (shown in FIG. 7) may be configured such that the remote communication device 300 may interface with the system 10 via the communication component 304. It should be noted, however, that the network 314 may be almost any type of network 314 and may be implemented as the World Wide Web (or Internet), a local area network (LAN), a wide area network (WAN), a metropolitan network, a wireless network, a cellular network, a Global System for Mobile communications (GSM) network, a code division multiple access (CDMA) network, a 3G network, a 4G network, a 5G network, a satellite network, a radio network, an optical network, a cable network, an Ethernet network, combinations thereof, and/or the like.

In one implementation, a server system 316 may implement the one or more processors 302 and the non-transitory computer readable medium 306 of the remote communication device 300. The server system 316 may have multiple servers in a configuration suitable to provide a commercial computer-based business system such as a commercial website and/or data center. The server system 316 may be configured to bi-directionally communicate one or more signals with the second control device 160 and/or network 314 as seen in FIG. 8. The one or more signals may be communicated to the second control device 160 via Bluetooth, WI-FI, network, DSL, or the like. The one or more signals may be communicated to the network 314 via Bluetooth, WI-FI, DSL, or the like.

Exemplary methods of simultaneously opening and closing the circuit of the system 10 are disclosed herein. By way of example, but in no way limiting, the control device 140 having the communication component may be described herein as the second control device 160, however, it would be understood by a person of ordinary skill in the art that the control device 140 can be any control device 140 having a communication component.

In one implementation, the method may comprise communicating a signal having processor executable instructions and/or code via the communication component 304 of the remote communication device 300 to the second control device 160 that when executed by the processor 163 of the second control device 160 opens or closes the circuit of the system 10 by not providing or providing electricity to the third control device 180.

In some non-limiting implementations, the method may comprise the communication component 304 of the remote communication device 300 communicating a signal to the second control device 160, wherein the signal comprises processor executable instructions/code that when executed by the processor 163 of the second control device 160 causes the second control device 160 to communicate electricity to the third control device 180 thereby closing the circuit of the system 10 by connecting a plurality of phases of electricity 186. In some non-limiting implementations, the method may further comprise generating the magnetic field M via the electrical coil 185 of the third control device 180 thereby causing the moving contacts 182 to move toward and engage with the fixed contacts 184 of the third control device 180 and close the circuit of the system 10 by connecting a plurality of phases of electricity 186.

In some non-limiting implementations, the method may comprise the communication component 304 of the remote communication device 300 communicating a signal to the second control device 160, wherein the signal comprises processor executable instructions/code that when executed by the processor 163 of the second control device 160 causes the second control device 160 to cease providing electricity to the third control device 180 and open the circuit of the system 10 by disconnecting a plurality of phases of electricity 186. In some non-limiting implementations, the method may further comprise the second control device 160 ceasing to communicate electricity to the third control device 180 such that the electrical coil 185 of the third control device 180 ceases to emit a magnetic field M thereby causing the moving contacts 182 disengage from the fixed contacts 184 of the third control device 180 and open the circuit of the system 10 by disconnecting a plurality of phases of electricity 186.

In some non-limiting implementations, the method may further comprise reducing electricity communicated from the power source when the electricity is greater than approximately 251 volts to approximately 120 volts via the voltage reduction device 220.

In some non-limiting implementations, the method may further comprise enabling the control device 140 to receive a signal from the remote communication device 300 by positioning the switch 142 of the first control device 140 in an auto position. In some non-limiting implementations, the method may further comprise the signal having processor executable instructions/code that when executed by the processor 163 of the second control device 160 causes the second control device 160 to communicate or cease communicating electricity to the third control device 180 thereby opening or closing the circuit of the system 10.

In some non-limiting implementations, the method may comprise closing the circuit of the system by positioning the switch 142 of the first control device 140 in the on position such that electricity may be communicated to the third control device 180, causing the electrical coil 185 of the third control device 180 to emit the magnetic field M, and thereby causing the moving contacts 182 to engage with the fixed contacts 184 and close the circuit of the system 10 by connecting a plurality of phases of electricity 186. In some non-limiting implementations, the method may further comprise positioning the switch 142 of the first control device 140 in the on position and engaging the momentary switch 144 of the first control device 140 such that electricity may be communicated to the third control device 180, causing the electrical coil 185 of the third control device 180 to emit the magnetic field M, and thereby causing the moving contacts 182 to engage with the fixed contacts 184 and close the circuit of the system 10 by connecting a plurality of phases of electricity 186.

In some non-limiting implementations, the method may comprise receiving electricity from the power source, communicating the electricity to the third control device 180, generating a magnetic field M via an electrical coil 185 of the third control device 180, engaging one or the plurality of moving contacts 182 with the plurality of fixed contacts 184 of the third control device 180, and closing the circuit of the system 10 by connecting a plurality of phases of electricity 186.

In some non-limiting implementations, the method may comprise the control device 140 having the switch 142 positioned in the off position such that the circuit of the system may be open and electricity to the components of the system 10 is disconnected.

### CONCLUSION

Conventionally, there is a need to develop a system and method for connecting and disconnecting a plurality of phases of electricity. The present disclosure by way of example, but in no way limiting, addresses these deficiencies with a methodology the components of the system described herein.

The foregoing description provides illustration and description but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A system, comprising:
a power source;
a receiving structure electrically coupled to a power source; and
a remote communication device configured to open or close a circuit between the power source and the receiving structure.

2. The system of claim 1, further comprising one or more control devices, wherein the one or more control devices includes a first control device comprising a first switch and a momentary switch, wherein the first switch has an on position, an off position, and an auto position.

3. The system of claim 2, further comprising a second control device configured to bi-directionally communicate with the remote communication device when the first switch of the first control device is positioned in the auto position.

4. The system of claim 3, wherein the second control device is configured to communicate electricity to the third control device.

5. The system of claim 2, further comprising a third control device configured to receive electricity from the first control device or the third control device when the first switch of the first control device is positioned in the on position and the momentary switch engaged.

6. The system of claim 1 further comprising an insulation device electrically coupled to the power source and receiving structure.

7. The system of claim 1, further comprising a voltage reduction device electrically coupled to the power source and the receiving structure.

8. The system of claim 1, further comprising a container.

9. The system of claim 8, further comprising one or more coupling points positioned within the container.

10. A method of controlling the flow of electricity from a power source to a receiving structure, comprising:
electrically coupling a power source to one or more control devices;
electrically coupling the one or more control devices to a receiving structure;
receiving a signal from a remote communication device, wherein the signal comprises processor executable instructions that when executed by a processor of the one or more control device causes the control device to open or close a circuit between the power source and the receiving structure.

11. The method of claim 10, further comprising:
providing a system, comprising:
a first control device coupled to the power source;
a second control device electrically coupled to the first control device; and
a third control device electrically coupled to the first control device, the second control device and the receiving structure; and
positioning a switch of the first control device in an auto position causing the second control device to open or close the circuit between the power source and the receiving structure upon receiving a signal.

12. The method of claim 11, further comprising:
communicating electricity from the second control device to the third control device;
generating a magnetic field from an electrical coil of the third control device; and
closing the circuit between the power source and the receiving structure.

13. The method of claim 12, wherein engaging a plurality of moving contacts of the third control device with a plurality of fixed contacts of the third control device causes the circuit between the power source and the receiving structure to close.

14. The method of claim 10, further comprising:
providing a system, comprising:
a first control device coupled to the power source;
a second control device electrically coupled to the first control device; and
a third control device electrically coupled to the first control device, the second control device and the receiving structure; and
positioning a switch of the first control device in an on position and having the momentary switch engaged thereby causing the circuit between the power source and the receiving structure to be closed.

15. The method of claim 14, further comprising:
communicating electricity from the first control device to the third control device;
generating a magnetic field from an electrical coil of the third control device;
closing the circuit between the power source and the receiving structure.

16. The method of claim 15, wherein engaging a plurality of moving contacts of the third control device with a plurality of fixed contacts of the third control device causes the circuit between the power source and the receiving structure to close.

17. The method of claim 11, further comprising:
receiving a signal from the remote communication device, wherein the signal comprises processor executable instructions and/or code that when executed by a processor of the second control device causes the second control device open or close the circuit between the power source and the receiving structure.

18. The method of claim 17, wherein the signal from the remote communication device comprises processor executable instructions and/or code comprising instructions to cease communicating electricity to the third control device, thereby causing the circuit between the power source and receiving structure to open.

19. The method of claim 18, further comprises:
ceasing to produce a magnetic field from an electrical coil of the third control device thereby causing a plurality of moving contacts of the third control device to disengage from a plurality of fixed contacts of the third control device thereby causing the circuit between the power source and the receiving structure to open.

20. The method of claim 10, further comprising:
reducing electricity from the power source greater than approximately 251 volts to approximately 120 volts.
